(19) United States
(12) Patent Application Publication
(10) Pub. No.: US 2017/0335773 A1
(43) Pub. Date: Nov. 23, 2017

(54) Gas Turbine Power Generation System

(71) Applicant: Hitachi, Ltd., Tokyo (JP)

(72) Inventors: Tomofumi SHIRAISHI, Tokyo (JP); Naohiro KUSUMI, Tokyo (JP); Noriaki HINO, Tokyo (JP); Aung Ko THET, Tokyo (JP); Masatoshi YOSHIMURA, Tokyo (JP)

(21) Appl. No.: 15/533,105

(22) PCT Filed: Dec. 15, 2014
(86) PCT No.: PCT/JP2014/083125

§ 371 Date: Jun. 5, 2017

(51) Int. Cl. F02C 7/32; F01D 15/10; H02K 7/18; F02C 3/04; F02C 7/20

(52) U.S. Cl. CPC F02C 7/32; F02C 3/04; F02C 7/20; H02K 7/1823; F01D 15/10; F05D 2220/76; F05D 2240/60; F05D 2220/32

(57) ABSTRACT

This gas turbine power generation system includes: a two-shaft gas turbine; a power generator that is driven by the two-shaft gas turbine and that generates power; an electric motor that is driven by power generated by the power generator; and a frequency converter that converts a frequency of the power that is transmitted between the power generator and the electric motor. The frequency converter is disposed within a predetermined range near the electric motor at the side opposite to the two-shaft gas turbine side relative to the electric motor so as to face the plane perpendicular to a rotation shaft of the electric motor.

### TECHNICAL FIELD

The present invention relates to a gas turbine power generation system using a two-shaft gas turbine.

### BACKGROUND ART

Regarding a gas turbine power generation system, PTL 1 discloses a gas turbine power generation system in which a compressor and a high-pressure gas turbine are connected to each other by a first rotation shaft, an electric motor is connected to the first rotation shaft, a low-pressure gas turbine and a power generator are connected to each other by a second rotation shaft, and the frequency of electric power transmitted between the power generator and the electric motor is converted by a frequency converter.

### CITATION LIST

### Patent Literature

PTL 1: International Publication WO 2014/020772

### SUMMARY OF INVENTION

### Technical Problem

In the gas turbine power generation system disclosed in PTL 1, the high-pressure side turbine and the low-pressure side turbine can be operated at different rotational speeds. Since the power generator is connected to the low-pressure side turbine, the low-pressure side turbine is operated at a constant rotational speed. Meanwhile, the high-pressure side turbine can achieve a high efficiency by changing the rotational speed depending on the load of the low-pressure side turbine. When the change speed of the load of the low-pressure side turbine is large, the electric motor is caused to function as the power generator by the inertia energy due to the rotation of the high-pressure side turbine in accordance with the variation, and the power is supplied to the load side through the frequency converter. Meanwhile, the electric energy of the power generator is converted into the inertial energy due to rotation of the high-pressure side turbine through the frequency converter in accordance with the variation.

When operating the electric motor at variable speed using the frequency converter, the frequency of the three-phase AC power source from the frequency converter is varied. The frequency converter and the electric motor are connected by a power cable for three-phase AC for power supply, but when the length of the power cable becomes longer, the resistance of the power cable itself increases and loss increases. Also, when the length of the power cable for three-phase AC differs between the respective phases, the resistance of the power cable itself changes, and influences the control of the electric motor. Also, a so-called LC circuit is formed by the inductor component and the capacitor component of the power cable itself, and when three-phase AC in which frequency varies is supplied to the LC circuit, high frequency is generated and influences the control of the electric motor.

The present invention has been made in view of the above circumstances, and an object thereof is to provide a gas turbine power generation system capable of suppressing the influence on the control of an electric motor caused by the power cable between the electric motor and the frequency converter.

### Solution to Problem

In order to solve the above issue, a gas turbine power generation system according to an aspect of the present invention includes: a two-shaft gas turbine; a power generator driven by the two-shaft gas turbine to generate electric power; an electric motor driven by the electric power from the power generator; and a frequency converter which converts the frequency of the electric power transmitted between the power generator and the electric motor, wherein the frequency converter is disposed to face a plane perpendicular to a rotation shaft of the electric motor on a side of the electric motor opposite to the two-shaft gas turbine side and at a position near a predetermined range around the electric motor.

In addition, a gas turbine power generation system according to an aspect of the present invention includes: a two-shaft gas turbine installed on a floor surface; a power generator driven by the two-shaft gas turbine to generate electric power; an electric motor driven by the electric power from the power generator; and a frequency converter which converts a frequency of the electric power transmitted between the power generator and the electric motor, wherein the frequency converter is disposed to intersect with a plane orthogonal to a rotation shaft of the electric motor and to face a plane including the rotation shaft of the electric motor and perpendicular to the floor surface.

### Advantageous Effects of Invention

According to the invention, it is possible to provide a gas turbine power generation system capable of suppressing the influence on the control of the electric motor caused by the power cable between the electric motor and the frequency converter.

### BRIEF DESCRIPTION OF DRAWINGS

FIG. 1 illustrates a schematic view of an overall configuration of a gas turbine power generation system according to a first embodiment.

FIGS. 2(a) and 2(b) illustrate schematic views of a device arrangement of the gas turbine power generation system in the first embodiment, FIG. 2(a) is a plan view thereof, and FIG. 2(b) is a front view thereof.

FIG. 3 illustrates a schematic view of an overall configuration of a gas turbine power generation system according to a second embodiment.

FIGS. 4(a) and 4(b) illustrate schematic views of a device arrangement of the gas turbine power generation system in the second embodiment, FIG. 4(a) is a plan view thereof, and FIG. 4(b) is a front view thereof.

FIGS. 5(a) and 5(b) illustrate schematic views of a device arrangement of a gas turbine power generation system in a third embodiment, FIG. 5(a) is a plan view thereof, and FIG. 5(b) is a front view thereof.

FIGS. 6(a) and 6(b) illustrate schematic views of a device arrangement of a gas turbine power generation system in a fourth embodiment, FIG. 6(a) is a plan view thereof, and FIG. 6(b) is a front view thereof.

FIGS. 7(a) and 7(b) illustrate schematic views of a device arrangement of a gas turbine power generation system in a fifth embodiment, FIG. 7(a) is a plan view thereof, and FIG. 7(b) is a front view thereof.

FIGS. 8(a) and 8(b) illustrate schematic views of a device arrangement of a gas turbine power generation system in a sixth embodiment, FIG. 8(a) is a plan view thereof, and FIG. 8(b) is a front view thereof.

FIGS. 9(a) and 9(b) illustrate schematic views of a device arrangement of a gas turbine power generation system in a seventh embodiment, FIG. 9(a) is a plan view thereof, and FIG. 9(b) is a front view thereof.

FIGS. 10(a) and 10(b) illustrate schematic views of a device arrangement of a gas turbine power generation system in an eighth embodiment, FIG. 10(a) is a plan view thereof, and FIG. 10(b) is a front view thereof.

FIGS. 11(a) and 11(b) illustrate schematic views of a device arrangement of a gas turbine power generation system in a ninth embodiment, FIG. 11(a) is a plan view thereof, and FIG. 11(b) is a front view thereof.

### DESCRIPTION OF EMBODIMENTS

### First Embodiment

A gas turbine power generation system according to a first embodiment of the present invention will be described below with reference to the drawings.

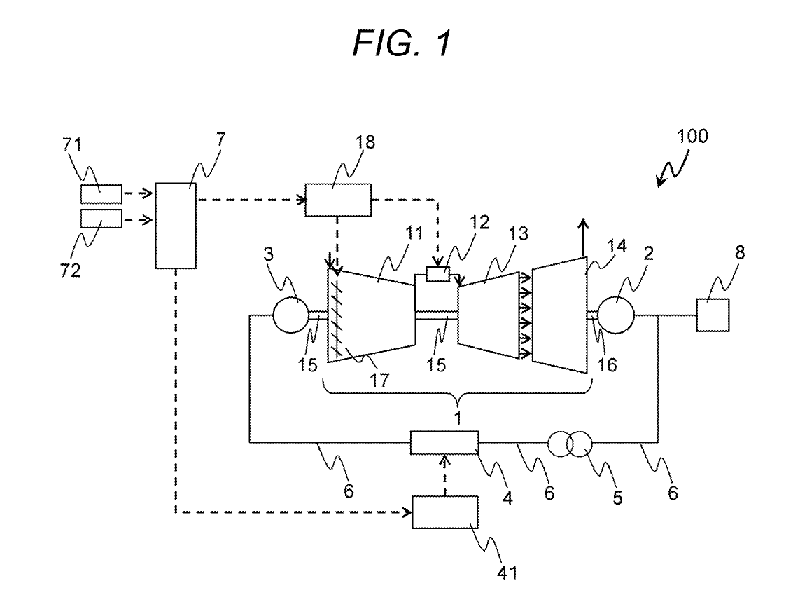

FIG. 1 illustrates a schematic view of the entire configuration of a gas turbine power generation system 100 according to a first embodiment.

As illustrated in FIG. 1, the gas turbine power generation system 100 mainly includes a two-shaft gas turbine 1, a power generator 2, an electric motor 3, a frequency converter 4, a transformer 5, and a control device 7.

The two-shaft gas turbine 1 includes a compressor 11, a combustor 12, a high-pressure turbine 13, a high-pressure side rotation shaft 15, a low-pressure turbine 14, a low-pressure side rotation shaft 16, and a speed governor 18.

The compressor 11 pressurizes the taken-in air to generate compressed air. The combustor 12 adds fuel to the compressed air to generate a combustion gas. The high-pressure turbine 13 is driven by the combustion gas. The high-pressure side rotation shaft 15 connects the electric motor 3, the compressor 11, and the high-pressure turbine 13. The low-pressure turbine 14 is driven by the combustion gas after driving the high-pressure turbine 13. The low-pressure side rotation shaft 16 connects the power generator 2 and the low-pressure turbine 14. The speed governor 18 adjusts the rotational speed and the output of the two-shaft gas turbine 1, by adjusting the amount of air taken into the compressor 11 by an angle of an inlet guide vane 17 serving as a flow regulating valve provided in an intake port of the compressor 11, and the amount of fuel added by the combustor 12.

The electric motor 3 is a three-phase induction motor which is mechanically connected to the high-pressure side rotation shaft 15 without using a gear, and the high-pressure side rotation shaft 15 and the rotation shaft of the electric motor 3 are configured to be coaxial to each other. The power generator 2 is driven by the low-pressure turbine 14 to generate electric power. The electric power generated by the power generator 2 is supplied to the external system 8. In addition, the electric power generated by the power generator 2 is also supplied to the electric motor 3 via the power cable 6. As a result, the electric motor 3 is driven to apply a rotational force to the high-pressure side rotation shaft 15. The frequency converter 4 is provided on the power cable 6 which connects the power generator 2 and the electric motor 3, and executes frequency conversion of electric power transmitted between the power generator 2 and the electric motor 3, and switching of the transmission direction of electric power. The control device 7 controls the entire gas turbine power generation system 100. The transformer 5 is provided on the power cable 6 and executes voltage conversion of electric power transmitted between the power generator 2 and the frequency converter 4.

The frequency converter 4 is controlled by the frequency converter control device 41. The frequency converter control device 41 controls the frequency conversion of the electric power transmitted between the power generator 3 and the electric motor 2 and switching of the transmission direction of the electric power, on the basis of the control command from the control device 7.

Torque applied to the compressor 11 via the high-pressure side rotation shaft 15 by the electric motor 3 is controlled by the frequency converter control device 41, and is capable of performing the variable speed-controlling of the compressor 11. That is, if an assist control is performed to apply torque from the electric motor 3 to the compressor 11, the rotation is accelerated, and if a brake is controlled to apply torque from the compressor 11 to the electric motor 3, the rotation is reduced. Among them, at the time of brake control, the electric motor 3 operates as a power generator, and the electric power is supplied to the external system 8 via the frequency converter 4 and the transformer 5.

The control device 7 controls the frequency converter control device 41 and the speed governor 18 on the basis of an electric power supply command value 71 from an upper-level control device (or a central power supply command station) and measurement results from an outside air condition measuring device 72 which measures a state quantity (temperature, humidity, and pressure) of air taken into the compressor 1, thereby controlling the total output of the output of the two-shaft gas turbine 1, that is, the output of the power generator 2 and the output of the electric motor 3. That is, the control device 7 performs the control so that the total value of the output of the two-shaft gas turbine 1, that is, the output of the power generator 2 and the output of the electric motor 3 is equal to the electric power output command value 71. Here, the output of the electric motor 3 is defined as taking a negative value at the time of the assist control and a positive value at the time of the brake control.

Next, an arrangement configuration of a configuration device of the gas turbine power generation system 100 will be described.

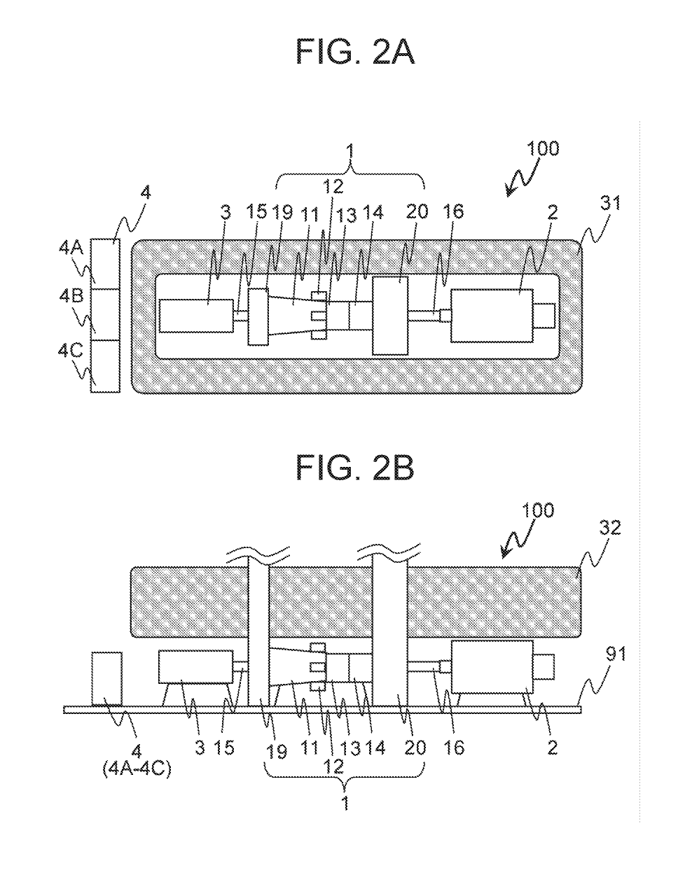

FIGS. 2(a) and 2 (b) illustrate schematic views of a device arrangement of the gas turbine power generation system 100 according to the first embodiment, FIG. 2(a) is a plan view thereof, and FIG. 2(b) is a front view thereof.

As compared with FIG. 1, FIGS. 2(a) and 2(b) illustrate an intake duct 19, an exhaust duct 20, and a floor surface 91 of a level on which the two-shaft gas turbine 1 is installed. In addition, the compressor 11, the high-pressure turbine 13, and the low-pressure turbine 14 are stored in a container (not illustrated) called a casing, and their appearances are integrated with each other. A plurality of combustors 12 is installed between the compressor 11 and the high-pressure turbine 13 outside the casing. FIGS. 2(a) and 2(b) illustrate an example in which the four combustors 12 are installed. The intake duct 19 is connected to an air inlet of the compressor 11, and air is taken into the compressor 11 from the intake duct 19. The exhaust duct 20 is connected to an exhaust outlet of the low-pressure turbine 14, and the combustion gas working in the high-pressure turbine 13 and the low-pressure turbine 14 is discharged from the exhaust duct 20.

Further, the frequency converter 4 includes three control panels 4A to 4C corresponding to each phase (U, V, and W) of the electric motor 3 which is a three-phase induction motor. Since the electric circuits stored in the housing of each of the control panels 4A to 4C generate heat during operation, the control panels 4A to 4C have a cooling device such as a fan for the purpose of protecting the electric circuits. The power cable 6 (not illustrated in FIGS. 2(a) and 2(b)) extends from each control panels 4A to 4C of the frequency converter 4 to the electric motor 3, and is connected to each terminal of the electric motor 3. Further, the lengths of each power cable 6 are configured to be equal to each other. Thus, the resistance of each power cable 6 is set to be equal to each other and the influence on the control of the electric motor 3 is eliminated.

A region 31 of FIG. 2(a) is a space required as a work place when checking and inspecting the two-shaft gas turbine 1, the electric motor 3, the power generator 2, and the frequency converter 4 among the regions on the floor surface 91 of the turbine building, and the region 31 is a region on which the device cannot be permanently placed. At the time of checking and inspection of the two-shaft gas turbine 1, the casing is opened to check and inspect the blades and shafts of the compressor 11, the high-pressure turbine 13, and the low-pressure turbine 14. The opened casing is temporarily placed in the region 31. In addition, the region 31 is used as a work place even when checking and inspecting the power generator 2 and the electric motor 3. The region 31 is a region that surrounds both sides and both ends of the two-shaft gas turbine 1, the electric motor 3, and the power generator 2.

In addition, since each device of the gas turbine power generation system 100 is heavy, a crane is required at the time of checking and inspection. In a turbine building in which the gas turbine power generation system 100 is installed, an overhead crane is usually installed. A region 32, which is an upper space portion of the gas turbine power generation system 100, is a region in which it is not possible to place a device which disturbs the crane operation. The intake duct 19 and the exhaust duct 20 are piped so as not to disturb the crane operation.

Further, the frequency converter 4 is installed in a region which deviates from the regions 31 and 32. In the present embodiment, the frequency converter 4 is disposed to face a plane perpendicular to the rotation shaft of the electric motor 3 on the side of the electric motor 3 opposite to the two-shaft gas turbine 1 side and at a position near a predetermined range around the electric motor 3. Specifically, the frequency converter 4 is disposed on the floor surface 91 so as to face the electric motor 3 in a direction along the rotation shaft of the electric motor 3, and the three control panels 4A to 4C are disposed side by side in parallel to the plane perpendicular to the rotation shaft of the electric motor 3. Here, the position near a predetermined range around the electric motor 3 is a position near the region 31, which is a position near a minimum range necessary for checking and inspection of the electric motor 3 and the control panels 4A to 4C. For example, when doors of the control panels 4A to 4C are opened to the side of the electric motor 3 in checking and inspection, a distance corresponding to the size of the door is required as a minimum necessary range.

As described above, in the present embodiment, the frequency converter 4 is disposed at a position near the predetermined range around the electric motor 3 so as to face the plane perpendicular to the rotation shaft of the electric motor 3. As a result, it is possible to secure a working space at the time of checking and inspection of the electric motor 3 and the frequency converter 4. In addition, since it is possible to suppress the power cable length of the power cable 6 between the electric motor 3 and the frequency converter 4, it is possible to suppress a loss due to the resistance of the power cable 6 itself and an occurrence of high frequency caused by the inductor components and the capacitor components of the power cable 6 itself, and it is possible to suppress the influence on the control of the electric motor 3. Further, it is possible to reduce the cost of the power cable 6.

Further, since the frequency converter 4 is installed on the side of the electric motor 3 opposite to the two-shaft gas turbine 1 side, the frequency converter 4 can be installed at a position apart from the devices which form the two-shaft gas turbine 1 and operates with high heat (the combustor 12, the high-pressure turbine 13, the low-pressure turbine 14, and the like). Therefore, the cooling efficiency of the frequency converter 4 can be enhanced.

Further, since the frequency converter 4 is disposed to face the electric motor 3 in the direction along the rotation shaft of the electric motor 3, it is possible to minimize the length of the power cable 6. Therefore, it is possible to further suppress the loss due to the resistance of the power cable 6 itself and an occurrence of the high frequency due to the inductor component and the capacitor component of the power cable 6 itself.

The three control panels 4A to 4C of the frequency converter 4 are arranged side by side in parallel to a plane perpendicular to the rotation shaft of the electric motor 3. Therefore, it is possible to minimize the length of the power cable 6 between the electric motor 3 and the control panels 4A to 4C.

### Second Embodiment

Next, a gas turbine power generation system according to a second embodiment of the present invention will be described. The same members as those of the first embodiment are denoted by the same reference numerals, a description thereof will not be provided, and different parts will be described.

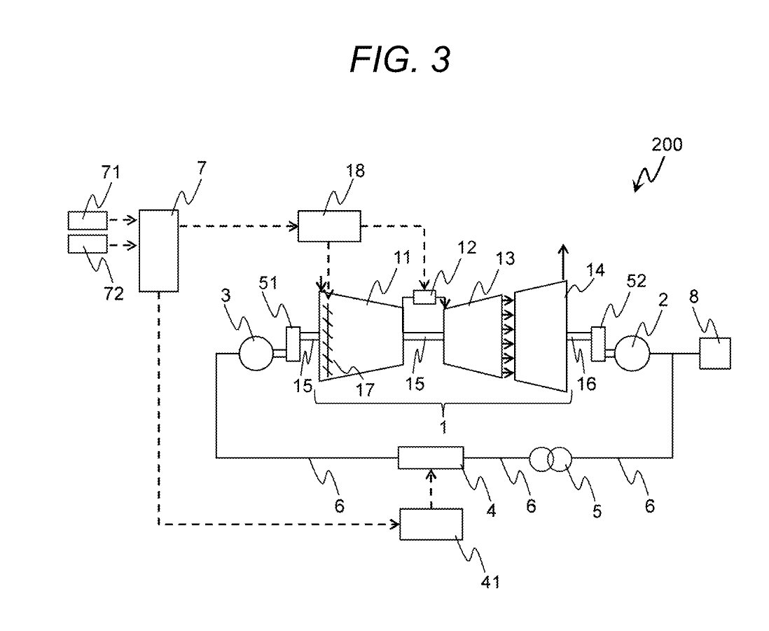

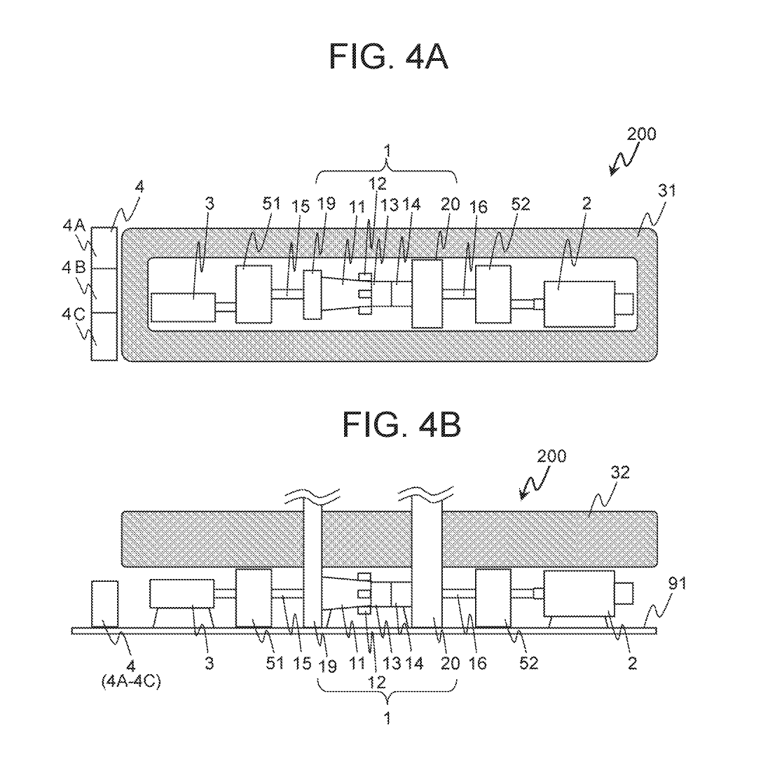

FIG. 3 illustrates a schematic view of the overall configuration of the gas turbine power generation system 200 according to the second embodiment. FIGS. 4(a) and 4(b) illustrate schematic views of the device arrangement of the gas turbine power generation system 200 according to the second embodiment, FIG. 4(a) is a plan view thereof, and FIG. 4(b) is a front view thereof.

In the first embodiment, the high-speed side rotation shaft 15 and the electric motor 3 are directly connected to each other without using a gear or the like, and the low-pressure side rotation shaft 16 and the power generator 2 are directly connected to each other without using a gear or the like. In contrast, in the present embodiment, as illustrated in FIG. 3, the high-speed side rotation shaft 15 and the electric motor 3 are connected to each other via a gear 51, and the low-pressure side rotation shaft 16 and the power generator 2 are connected to each other via a gear 52.

Also, in the present embodiment, as illustrated in FIGS. 4(a) and 4(b), the frequency converter 4 is disposed to face a plane perpendicular to the rotation shaft of the electric motor 3, on the side of the electric motor 3 opposite to the two-shaft gas turbine 1 side and at a position near a predetermined range around the electric motor 3. Specifically, the frequency converter 4 is disposed on the floor surface 91 so as to face the electric motor 3 in a direction along the rotation shaft of the electric motor 3, and the three control panels 4A to 4C are arranged side by side in parallel to a plane perpendicular to the rotation shaft of the electric motor 3. With such a configuration, the gas turbine power generation system 200 of the present embodiment can also achieve the same effects as those of the gas turbine power generation system. 100 of the first embodiment.

Further, by connecting the high-pressure side rotation shaft 15 and the electric motor 3 via the gear 51, the rotational speed of the electric motor 3 can be changed and transmitted to the high-pressure side rotation shaft 15. Therefore, even if the rotational speeds of the high-pressure side rotation shaft 15 and the electric motor 3 are different from each other, there is no need to specially prepare an electric motor. Therefore, it is possible to use a general-purpose electric motor and suppress an increase in cost. Similarly, by using the gear 52 between the low-pressure side rotation shaft 16 and the power generator 2, it is possible to use a general-purpose power generator and suppress an increase in cost.

In the present embodiment, although gears are used between the high-pressure side rotation shaft 15 and the electric motor 3, and between the low-pressure side rotation shaft 16 and the power generator 2, the gears may be used in only one part. Even in this case, an increase in cost can be suppressed by using a general-purpose electric motor or a generator.

### Third Embodiment

Next, a gas turbine power generation system according to a third embodiment of the present invention will be described. The same members as those of the first embodiment are denoted by the same reference numerals, a description thereof will not be provided, and different parts will be described.

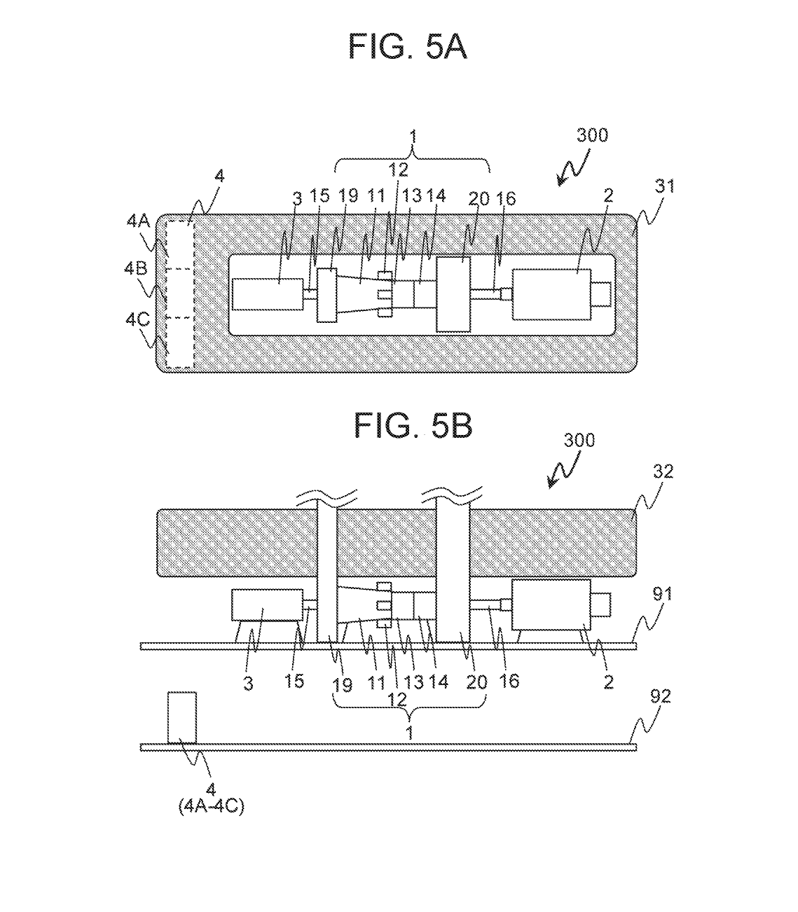

FIGS. 5(a) and 5(b) illustrate schematic views of a device arrangement of a gas turbine power generation system 300 according to a third embodiment, FIG. 5(a) is a plan view thereof, and FIG. 5(b) is a front view thereof.

In the present embodiment, the frequency converter 4 is not installed on the floor surface 91 of the level on which the two-shaft gas turbine 1 is installed, but the frequency converter 4 is installed on a floor surface 92 of a level just below this level. The floor surface 92 is not illustrated in FIG. 5(a). Also, in this embodiment, as illustrated in FIGS. 5(a) and 5(b), the frequency converter 4 is disposed to face a plane perpendicular to the rotation shaft of the electric motor 3, on the side of the electric motor 3 opposite to the two-shaft gas turbine 1 side and at a position near a predetermined range around the electric motor 3. Further, the frequency converter 4 is disposed on the floor surface 92 so as to intersect with a plane including the rotation shaft of the electric motor 3 and perpendicular to the floor surface 91 at a position overlapping the region 31 in the vertical direction. The position near the predetermined range around the electric motor 3 in the present embodiment is a position near the lower side of the region 31.

With such a configuration, the gas turbine power generation system 300 of the present embodiment can also achieve the same effects as those of the gas turbine power generation system 100 of the first embodiment. Furthermore, the work place around the electric motor 3 becomes wider, which makes the work easier.

### Fourth Embodiment

Next, a gas turbine power generation system according to a fourth embodiment of the present invention will be described. The same members as those of the first embodiment are denoted by the same reference numerals, a description thereof will not be provided, and different parts will be described.

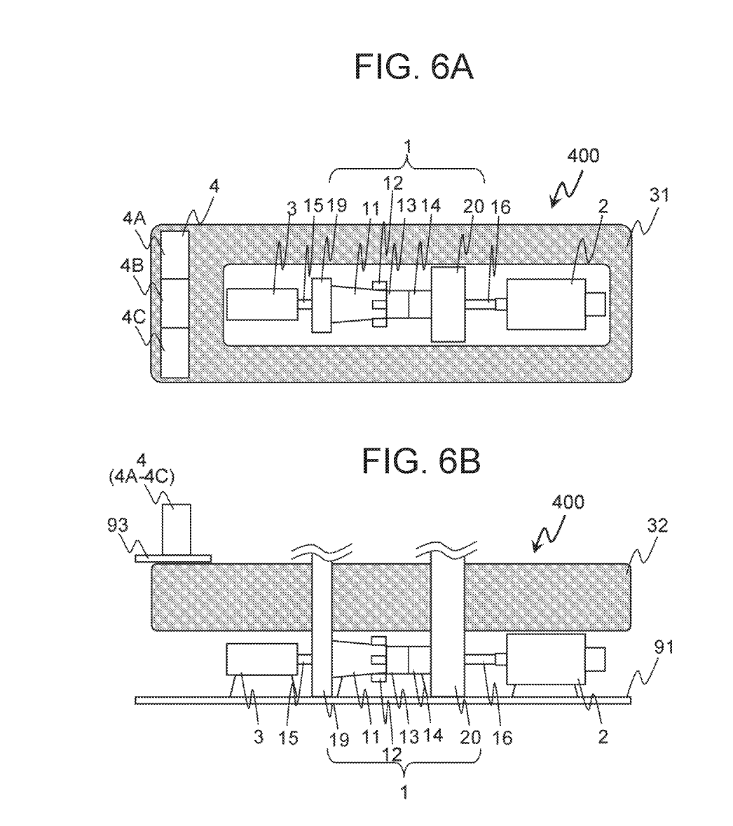

FIGS. 6(a) and 6(b) illustrate schematic views of a device arrangement of a gas turbine power generation system 400 according to a fourth embodiment, FIG. 6(a) is a plan view thereof, and FIG. 6(b) is a front view thereof.

In the present embodiment, the frequency converter 4 is not installed on the floor surface 91 of the level on which the two-shaft gas turbine 1 is installed, but the frequency converter 4 is installed on a floor surface 93 of a level just above this level. Further, the floor surface 93 is not illustrated in FIG. 6(a). As illustrated in FIGS. 6(a) and 6(b), the frequency converter 4 is disposed to face a plane perpendicular to the rotation shaft of the electric motor 3, on the side of the electric motor 3 opposite to the two-shaft gas turbine 1 side and at a position near a predetermined range around the electric motor 3. Further, the frequency converter 4 is disposed on the floor surface 93 so as to intersect with a plane including the rotation shaft of the electric motor 3 and perpendicular to the floor surface 91 at a position overlapping the region 31 in the vertical direction. A position near the predetermined range around the electric motor 3 in the present embodiment is a position near the upper side of the region 32.

With such a configuration, the gas turbine power generation system 400 of the present embodiment can also achieve the same effects as those of the gas turbine power generation system 100 of the first embodiment. Furthermore, the work place around the electric motor 3 becomes wider, which makes the work easier.

### Fifth Embodiment

Next, a gas turbine power generation system according to a fifth embodiment of the present invention will be described. The same members as those of the first embodiment are denoted by the same reference numerals, a description thereof will not be provided, and different parts will be described.

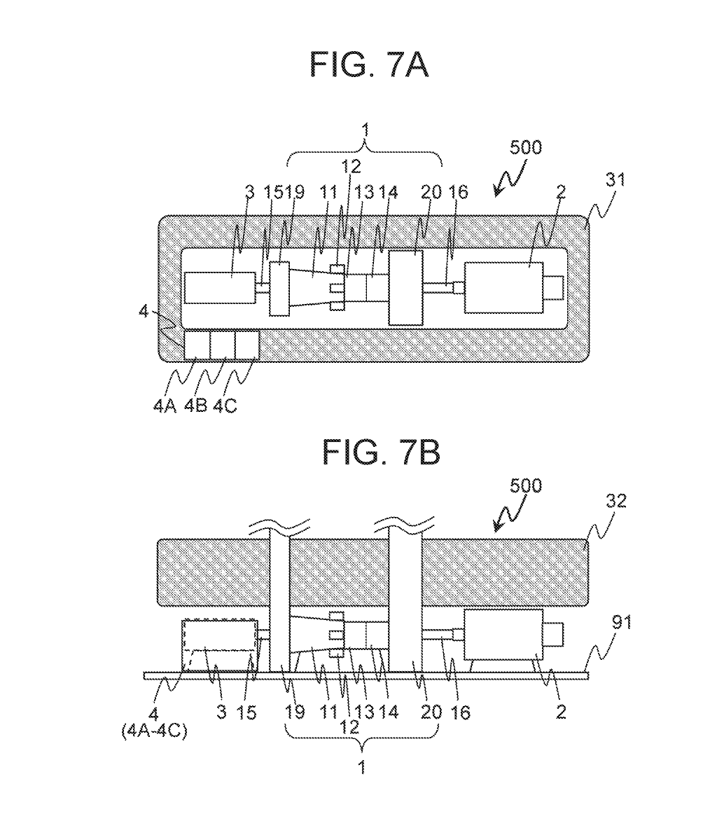

FIGS. 7(a) and 7(b) illustrate schematic views of a device arrangement of a gas turbine power generation system 500 in a fifth embodiment, FIG. 7(a) is a plan view thereof, and FIG. 7(b) is a front view thereof.

In the present embodiment, the frequency converter 4 is installed on the lateral side of the electric motor 3. Specifically, the frequency converter 4 is disposed to intersect with a plane orthogonal to the rotation shaft of the electric motor 3 and to face the plane perpendicular to the floor surface 91 through the rotation shaft of the electric motor 3. Further, the frequency converter 4 is disposed to face the electric motor 3, in a direction orthogonal to the rotation shaft of the electric motor 3 and parallel to the floor surface 91. Further, the three control panels 4A to 4C are arranged side by side in parallel to a plane including the rotation shaft of the electric motor 3 and perpendicular to the floor surface 91. The frequency converter 4 is disposed in the region 31.

With such a configuration, the gas turbine power generation system 500 of the present embodiment can also achieve the same effects as those of the gas turbine power generation system 100 of the first embodiment. Furthermore, it is possible to shorten the length of the gas turbine power generation system 500 in the axial direction (an arrangement direction of the electric motor 3, the compressor 11, the high-pressure turbine 13, the low-pressure turbine 14, and the power generator 2). Therefore, it is possible to reduce the size of the building in which the gas turbine power generation system 500 is to be installed, and cost can be reduced.

### Sixth Embodiment

Next, a gas turbine power generation system according to a sixth embodiment of the present invention will be described. The same members as those of the first embodiment are denoted by the same reference numerals, a description thereof will not be provided, and different parts will be described.

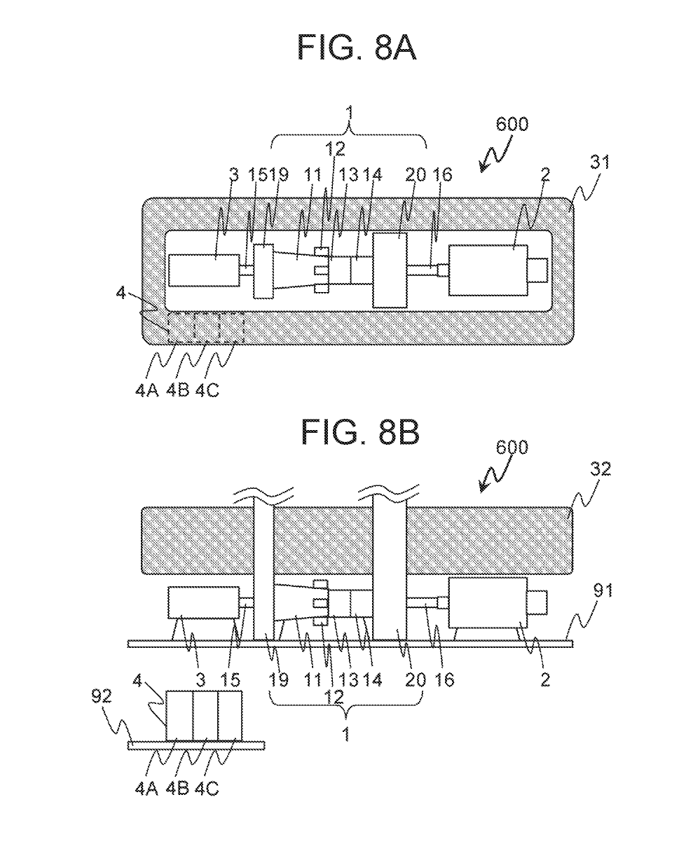

FIGS. 8(a) and 8(b) illustrate schematic views of a device arrangement of a gas turbine power generation system 600 according to a sixth embodiment, FIG. 8(a) is a plan view thereof, and FIG. 8(b) is a front view thereof.

In the present embodiment, the frequency converter 4 is not installed on the floor surface 91 of the level on which the two-shaft gas turbine 1 is installed, but the frequency converter 4 is installed on the floor surface 92 of a level below this level. The floor surface 92 is not illustrated in FIG. 8(a). Also, in the present embodiment, as illustrated in FIGS. 8(a) and 8 (b), the frequency converter 4 is disposed to intersect with a plane orthogonal to the rotation shaft of the electric motor 3 and to face the plane perpendicular to the floor surface 91 through the rotation shaft of the electric motor 3. Further, the frequency converter 4 is disposed at a position overlapping the region 31 in the vertical direction.

With such a configuration, the gas turbine power generation system 600 of the present embodiment can also achieve the same effects as those of the gas turbine power generation system 500 of the fifth embodiment. Furthermore, the work place around the electric motor 3 becomes wider, which makes the work easier.

### Seventh Embodiment

Next, a gas turbine power generation system according to a seventh embodiment of the present invention will be described. The same members as those of the first embodiment are denoted by the same reference numerals, a description thereof will not be provided, and different parts will be described.

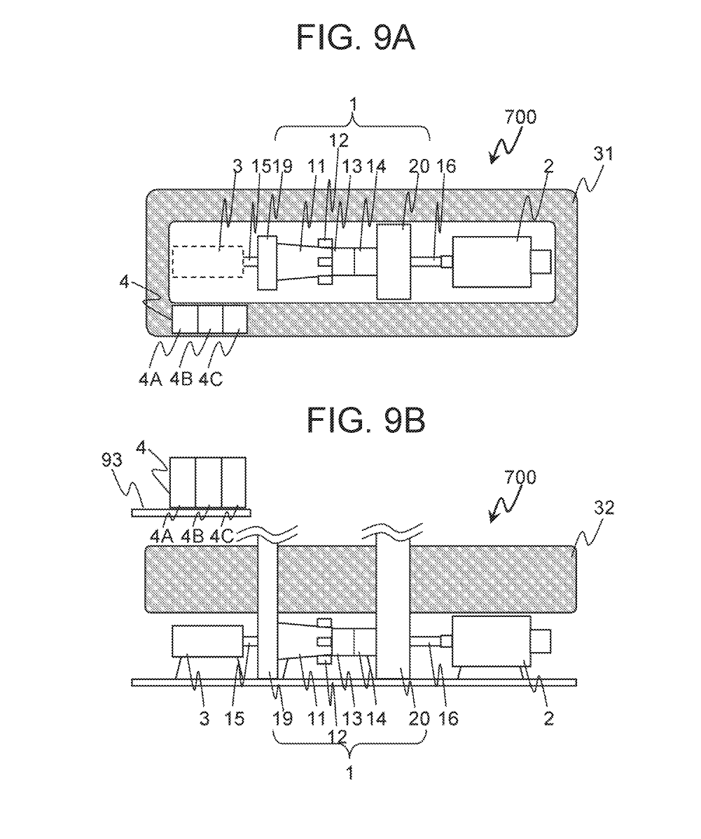

FIGS. 9(a) and 9 (b) illustrate schematic views of a device arrangement of a gas turbine power generation system 700 according to the seventh embodiment, FIG. 9(a) is a plan view thereof and FIG. 9(b) is a front view thereof.

In the present embodiment, the frequency converter 4 is not installed on the floor surface 91 of the level on which the two-shaft gas turbine 1 is installed, but the frequency converter 4 is installed on a floor surface 93 of a level above this level. In FIG. 9(a), the floor surface 93 is not illustrated. Also, in the present embodiment, as illustrated in FIGS. 8(a) and 8(b), the frequency converter 4 is disposed to intersect with a plane orthogonal to the rotation shaft of the electric motor 3 and to face a plane perpendicular to the floor surface 91 through the rotation shaft of the electric motor 3. Further, the frequency converter 4 is arranged at a position overlapping the region 31 in the vertical direction.

With such a configuration, the gas turbine power generation system 700 of the present embodiment can also achieve the same effects as those of the gas turbine power generation system 500 of the fifth embodiment. Furthermore, the work place around the electric motor 3 becomes wider, which makes the work easier.

### Eighth Embodiment

Next, a gas turbine power generation system according to an eighth embodiment of the present invention will be described. The same members as those of the first embodiment are denoted by the same reference numerals, a description thereof will not be provided, and different parts will be described.

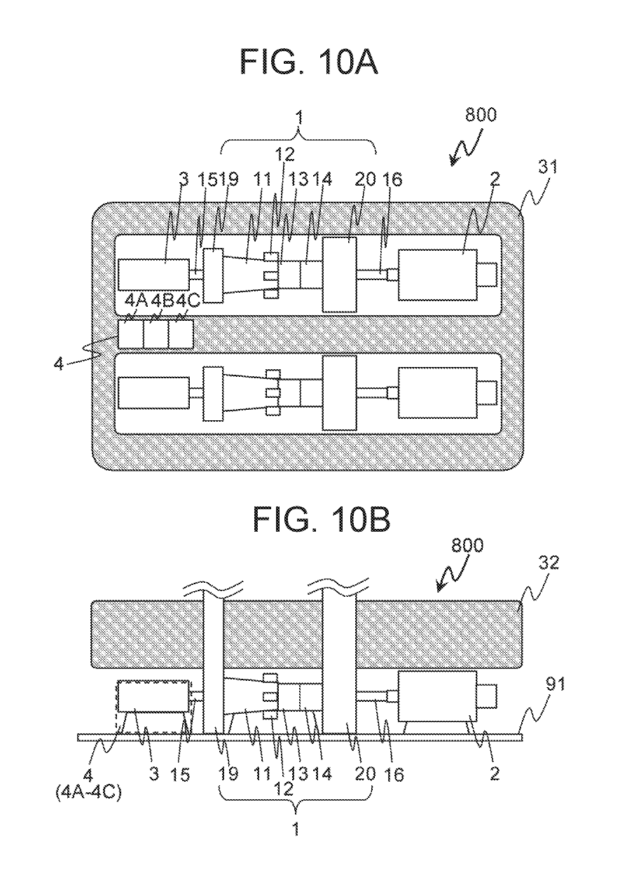

FIGS. 10(a) and 10(b) illustrate schematic views of a device arrangement of a gas turbine power generation system 800 according to an eighth embodiment, FIG. 10(a) is a plan view thereof, and FIG. 10(b) is a front view thereof.

As illustrated in FIGS. 10(a) and 10(b), the gas turbine power generation system 800 includes two electric motors 3, two compressors 11, two high-pressure turbines 13, two low-pressure turbines 14, and two power generators 2 arranged in parallel. One frequency converter 4, one frequency converter control device 41 (FIG. 1), one control device 7 (FIG. 1), and the like are provided in contrast to two configurations.

The frequency converter 4 is installed between the adjacent electric motors 3 to drive the two electric motors 3. Also, in the present embodiment, the frequency converter 4 is disposed to intersect with a plane orthogonal to the rotation shaft of the electric motor 3 and to face the plane perpendicular to the floor surface 91 through the rotation shaft of the electric motor 3. Further, the frequency converter 4 is disposed to face the electric motor 3, in a direction orthogonal to the rotation shaft of the electric motor 3 and parallel to the floor surface 91. Further, the three control panels 4A to 4C are arranged side by side in parallel to a plane including the rotation shaft of the electric motor 3 and perpendicular to the floor surface 91. The frequency converter 4 is disposed in the region 31.

With such a configuration, the gas turbine power generation system 800 of the present embodiment can also achieve the same effects as those of the gas turbine power generation system 500 of the fifth embodiment. Furthermore, by reducing the number of installed frequency converters 4, the work place around the electric motor 3 becomes wider, which makes the work easier.

### Ninth Embodiment

Next, a gas turbine power generation system according to a ninth embodiment of the present invention will be described. The same members as those of the first embodiment are denoted by the same reference numerals, a description thereof will not be provided, and different parts will be described.

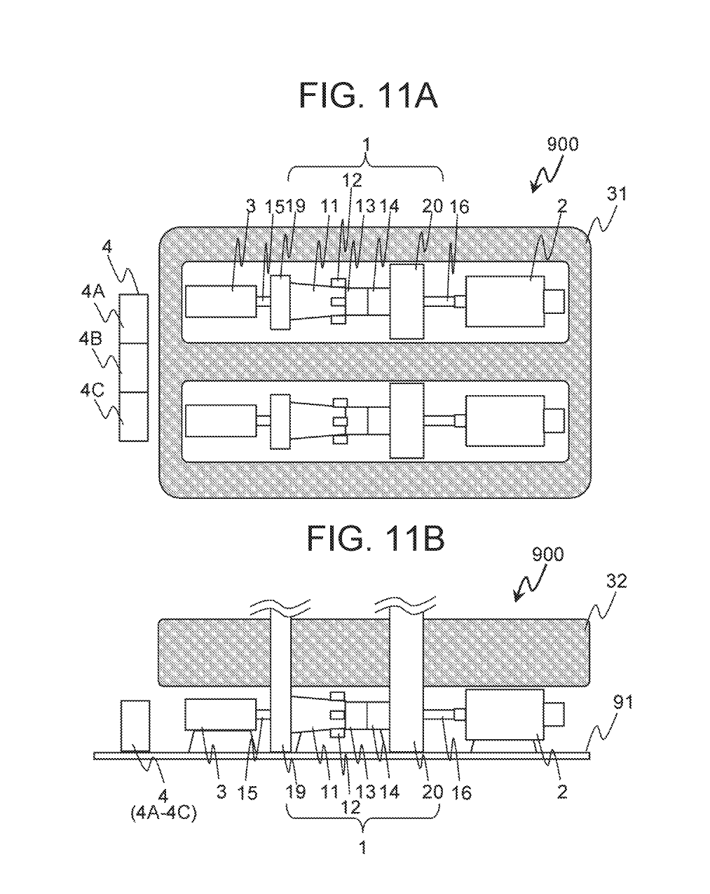

FIGS. 11(a) and 11(b) illustrate schematic views of a device arrangement of a gas turbine power generation system 900 according to a ninth embodiment, FIG. 11(a) is a plan view thereof, and FIG. 11(b) is a front view thereof.

As illustrated in FIGS. 11(a) and 11(b), the gas turbine power generation system 900 includes two electric motors 3, two compressors 11, two high-pressure turbines 13, two low-pressure turbines 14, and two power generators 2 arranged in parallel. One frequency converter 4, one frequency converter control device 41 (FIG. 1), one control device 7 (FIG. 1), and the like are provided in contrast to the two configurations. The two electric motors 3 are driven by one frequency converter 4.

The frequency converter 4 is disposed to face a plane perpendicular to the rotation shaft of the electric motor 3, on the side of the electric motor 3 opposite to the two-shaft gas turbine 1 side at a position near a predetermined range around the electric motor 3. The frequency converter 4 is disposed on the floor surface 91 to face the electric motor 3 in a direction along the rotation shaft of the electric motor 3.

With such a configuration, the gas turbine power generation system 800 of the present embodiment can also achieve the same effects as those of the gas turbine power generation system 100 of the first embodiment. Furthermore, by reducing the number of installed frequency converters 4, the work place around the electric motor 3 becomes wider, which makes the work easier.

The present invention is not limited to the above-described embodiments, and can be changed to various other forms without departing from the spirit thereof.

For example, the frequency converter 4 in the eighth and ninth embodiments may be installed on a floor surface just above or just below the floor surface 91, rather than on the floor surface 91.

### REFERENCE SIGNS LIST

1 two-shaft gas turbine
2 generator
3 electric motor
4 frequency converter
91, 92, 93 floor surface
100, 200, 300, 400, 500, 600, 700, 800, 900 gas turbine power generation system

1. A gas turbine power generation system comprising:
a two-shaft gas turbine;
a power generator driven by the two-shaft gas turbine to generate electric power;
an electric motor driven by the electric power from the power generator; and
a frequency converter which converts the frequency of the electric power transmitted between the power generator and the electric motor,
wherein the frequency converter is disposed to face a plane perpendicular to a rotation shaft of the electric motor on a side of the electric motor opposite to the two-shaft gas turbine side and at a position near a predetermined range around the electric motor.

2. The gas turbine power generation system according to claim 1, wherein the frequency converter is disposed to face the electric motor in a direction along the rotation shaft of the electric motor.

3. The gas turbine power generation system according to claim 1, wherein the electric motor is a three-phase induction motor,
the frequency converter has three control panels corresponding to each phase of three-phase AC, and
the three control panels are arranged side by side in parallel to the perpendicular plane.

4. The gas turbine power generation system according to claim 1, wherein the frequency converter is installed on a floor surface of a level just above or just below a floor surface of a level on which the two-shaft gas turbine, the power generator, and the electric motor are installed.

5. The gas turbine power generation system according to claim 1, further comprising:
a separate two-shaft gas turbine provided in parallel apart from the two-shaft gas turbine, the power generator, and the electric motor;
a separate power generator driven by the separate two-shaft gas turbine to generate electric power; and
a separate electric motor driven by the electric power from the separate power generator,
wherein the frequency converter converts a frequency of electric power transmitted between the separate power generator and the separate electric motor.

6. A two-shaft gas turbine power generation system comprising:
a two-shaft gas turbine installed on a floor surface;
a power generator driven by the two-shaft gas turbine to generate electric power;
an electric motor driven by the electric power from the power generator; and
a frequency converter which converts a frequency of the electric power transmitted between the power generator and the electric motor,
wherein the frequency converter is disposed to intersect with a plane orthogonal to a rotation shaft of the electric motor and to face a plane including the rotation shaft of the electric motor and perpendicular to the floor surface.

7. The gas turbine power generation system according to claim 6, wherein the frequency converter is disposed to face the electric motor in a direction orthogonal to the rotation shaft of the electric motor and parallel to the floor surface.

8. The gas turbine power generation system according to claim 6, wherein the electric motor is a three-phase induction motor,
the frequency converter has three control panels corresponding to each phase of three-phase AC, and
the three control panels are arranged side by side in parallel to a plane perpendicular to the floor surface.

9. The gas turbine power generation system according to claim 6, wherein the frequency converter is installed on a floor surface of a level just above or just below a floor surface of a level on which the two-shaft gas turbine, the power generator, and the electric motor are installed.

10. The turbine power generation system according to claim 1, further comprising:
a separate two-shaft gas turbine provided in parallel apart from the two-shaft gas turbine, the power generator, and the electric motor;
a separate power generator driven by the separate two-shaft gas turbine to generate electric power; and
a separate electric motor driven by the electric power from the separate power generator,
wherein the frequency converter is located between the electric motor and the separate electric motor to convert a frequency of electric power transmitted between the separate power generator and the separate electric motor.
